(19) United States
(12) Patent Application Publication
(10) Pub. No.: US 2007/0159940 A1
(43) Pub. Date: Jul. 12, 2007

(54) Drive and method for simulating the insertion of a new record

(75) Inventors: Pope Ijtsma, Eindhoven (NL); Johannis Friso Rendert Blacquiere, Eindhoven (NL); Dirk Hamelinck, Beerzel (BE); Justin Francois Paul-Marie Frints, Eindhoven (NL); Arnaud Frank Wilhelmine Gouder De Beauregard, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,188

(22) PCT Filed: Feb. 14, 2005
(86) PCT No.: PCT/IB05/50569

§ 371 Date: Aug. 21, 2006

(30) Foreign Application Priority Data
Feb. 26, 2004 (EP) 04100761.8

(51) Int. Cl. G11B 15/52; G11B 20/10; G11B 19/02; G11B 5/09

(52) U.S. Cl. 369/47.1

(57) ABSTRACT

The present invention relates to a drive (2) for use in a computer or a reproduction device for accessing a record carrier. According to the invention via a specific action, supervised by the drive (2), the drive mimics the presence of a disc by sending a disc insertion message to the host (3). After that the drive (2) will give the host (3) (the virtual) file system contents of the virtual disc, which, for instance, contains a link to an auto-run file. This auto-run file tells the host (3) to perform certain actions, such as going to the specified internet site or executing a file from the virtual disc.

The present invention relates to a drive for use in a computer or a reproduction device for accessing a record carrier, to a computer or a reproduction device having such a drive, to a method of simulating the insertion of a new record carrier and to a computer program for implementing said method.

In certain circumstances it may be needed to initiate a “dialog” with an application or a user to perform specific actions. An example related to, for instance, a special MRW disc (Mount Rainier disc of rewritable type), which is playable in CE (consumer equipment) devices, is that after changing the file content of a disc, a dialog must be started to ask the user if he likes to make his disc compliant with a legacy video player. There are several solutions known to start such a dialog. For example, the insertion of a medium can generate an insert notification to the operating system, which triggers the operating system to retrieve the file system information, after which an auto-run file could start a particular application. Another option is that the user starts such a dialog manually by means of an appropriate program, such as the Microsoft Explorer, after the disc insertion. However, sometimes this can not be done, for example when the drive does not contain a piece of media to start this process from this program.

It is an object of the present invention to provide a solution to the above described problem, in particular to provide a drive for use in a computer or a reproduction device, a device, in particular a computer or a reproduction device, having such a drive and a method of simulating the insertion of a new record carrier into the drive of a computer or a reproduction device which enable the start of an application or any other action even if no auto-run file is available on the disc or if no disc is available at all in the drive.

The object is achieved according to the present invention by a drive as claimed in claim 1 comprising:
an output means for outputting a new media inserted message indicating that a new record carrier has been inserted in response to a new media inserted trigger event irrespective of the physical insertion of a new record carrier and for outputting file system data in response to a read request,
a trigger registration means for checking the occurrence of said new media inserted trigger event,
an input means for receiving, in response to the output of said new media inserted message, said read request for reading and returning said file system data, and
a carrier access means for reading data from and/or recording data to a record carrier.

The object is further achieved by a device, in particular a computer or a reproduction device, as claimed in claim 9 having:
an operating system for operating the device, for running applications and for communicating with a drive,
a drive as claimed in claim 1,
   wherein said operating system is operative for outputting said read request for reading and returning said file system data to said drive and for evaluating said file system data outputted by said drive in response to said read request.

Further, the object is achieved by a method of simulating the insertion of a new record carrier into a drive of a computer or a reproduction device as claimed in claim 10 comprising the steps of:
checking the occurrence of a new media inserted trigger event,
outputting a new media inserted message indicating that a new record carrier has been inserted in response to said new media inserted trigger event irrespective of the physical insertion of a new record carrier,
receiving, in response to the output of said new media inserted message, a read request for reading and returning file system data, and
outputting said file system data in response to said read request.

A computer program for implementing said method is defined in claim 11. Preferred embodiments of the invention are defined in the dependent claims.

The present invention is based on the idea that the drive mimics the insertion and, preferably, content of a piece of media, including the file system on the disc and its file content. The result can be seen as a virtual disc. According to the invention, based on the occurrence of a new media inserted trigger event, which can be different events as defined in the dependent claims, the drive generates a new media inserted message signalling to the operating system of the computer (also called “host”) or the reproduction device that a new media has been inserted. However, according to the invention, this signal is generated irrespective of the physical insertion of a new media but only based on said trigger event.

Thus, if such an event occurs, even if no new media has been inserted physically into the drive, said new media inserted message will be outputted by the drive after which the operating system of the computer (or the reproduction device) sends a request to the drive to return file system data from a particular location of the record carrier. The drive will then return the requested file system data, which it takes from the requested location of the record carrier, if there is any record carrier present in the drive, or from a separate memory of the drive. The operating system may then evaluate the returned file system data and issue a further read request to the drive, for instance to access a different location of the record carrier, where, for instance, further file system data, an auto-run file or an application file are stored which may then be returned and executed by the computer (or the reproduction device).

For instance, an auto-run file can be started which may include a link to a certain application or perform any other action desired by the user or which is predetermined, for instance, by the manufacturer or the vendor of the drive. This process is thus controlled by the drive according to the present invention.

As mentioned above, the event that triggers the output of said new media inserted message can be different. Preferred embodiment for trigger registration means which check the occurrence of said event are defined in dependent claims and are adapted to the different embodiments of said events. For instance, said event could be an eject command given by a user to eject an inserted media from the drive, or the drive could have an internal timer or an internal clock so that said event is that a predetermined time duration has been elapsed or that a predetermined point in time has been reached.

Another event could be that a particular type of record carrier or a particular record carrier, for instance identified by a unique identifier, has been inserted into the drive whereupon a particular action shall be started, as for instance predetermined by the vendor of said record carriers. Thus, on said record carriers for example data or files could be stored in a special area which can be detected by the trigger registration means as said event whereupon the new media inserted message is outputted by the drive to the operating system.

In another embodiment the carrier access means is operative for reading data from a predetermined location from said record carrier when a trigger event appears. For instance, if special data is written at a certain location on the disc, the occurrence of the trigger event results in the drive generating the “new media inserted” signal. The drive may then change the offset of logical block address 0 such that logical block 16, for example, now lays inside the special data at the mentioned location on the disc. In practice the value for the offset could be written on the disc in a special table which could be stored at a certain predetermined location on the disc, or the value for the offset could be predefined by the vendor or producer of the drive. The user will experience this as a separate view on the disc.

According to another embodiment a user interface is provided in the drive which allows the user to input a trigger command, which may be a user button on the outside of the drive. If the user pushes the button the drive uses the trigger ability provided according to the invention to signal to the operating system that a new record carrier has been inserted and thereupon to contact, for example, the web-site of the vendor of the drive or the vendor of the PC (or the reproduction device) in order to download new firmware or update of programs for the drive or the PC (or the reproduction device).

According to another embodiment the event that triggers the output of said new media inserted message may be detection of an error during execution of a command by the disk drive, and/or the detection by the disk drive of an unknown command, and/or detection that a predetermined time of day/date has been reached. This type of event may be used for example to trigger an automatic download of new firmware for the drive via the Internet.

According to a further embodiment memory means are provided in the drive for storing file system data, which are outputted by the drive in response to a read request from the operating system of the PC. Thus, in case no disc is physically inserted in the drive, after occurrence of a trigger event and after signalling this to the operating system, file system data will be requested by the operating system which will, in this embodiment, be taken from the memory of the drive. Even further, the file system data may include a link to a data file, in particular to an auto-run file or an application file, and said data file itself can also be stored in said memory means. Also an application started by said auto-run file may be provided in the memory of the drive. This memory could be either a ROM or some form of non-volatile memory. The latter would allow to change the behavior of the virtual auto-run ability during the life of the PC drive, while a ROM memory does not allow that.

The invention will now be explained in more detail with reference to the drawings in which

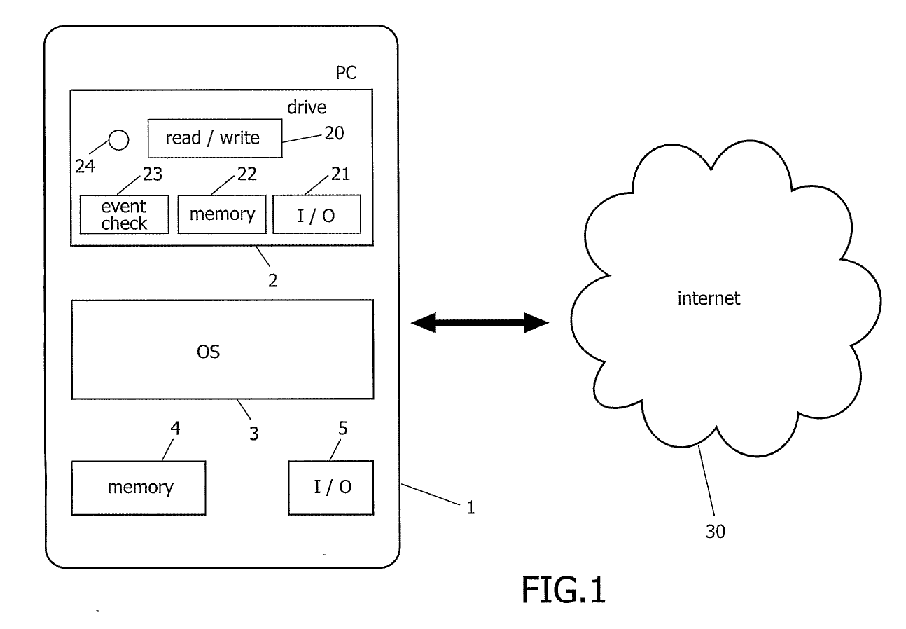

FIG. 1 shows a schematic block diagram of a computer according to the invention,

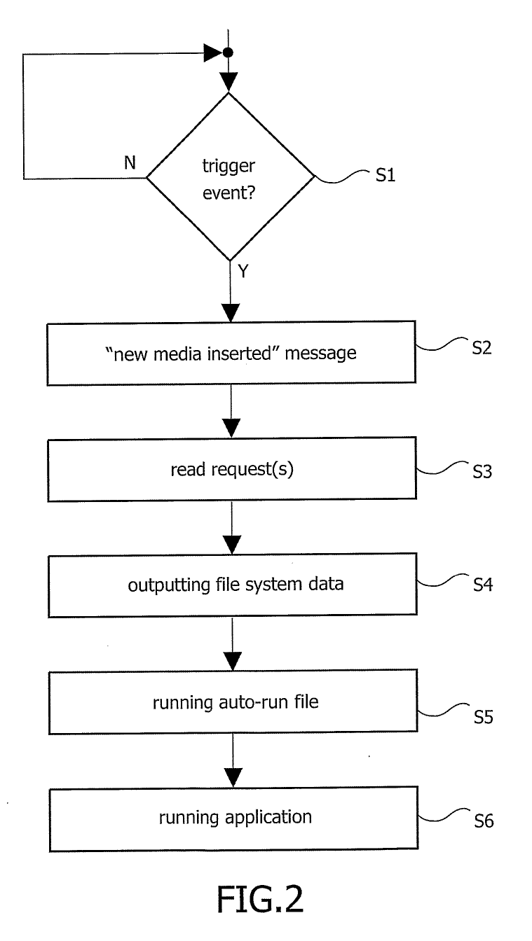

FIG. 2 shows a flow chart of the method according to the invention and

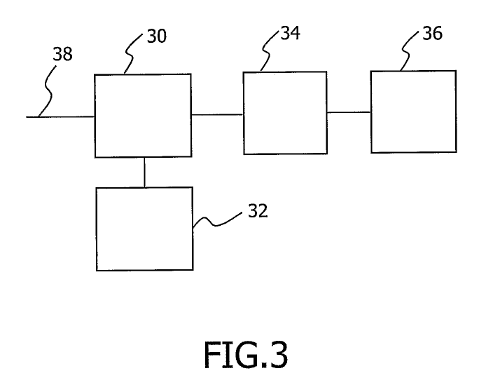

FIG. 3 shows an embodiment of a drive control circuit.

In the schematic diagram of FIG. 1 a computer 1 according to the present invention is shown. The computer comprises, among others, a drive 2 for accessing a record carrier, an operating system 3, a memory 4 and an input/output unit 5. The drive 2 comprises a carrier access means, i.e. a read/write unit 20 for reading data from and recording data to a record carrier, such as an optical disc, an input/output unit 21, a memory unit 22, a check unit 23 and a user interface 24, which is simply a user button in this embodiment. Further, in this embodiment, the computer is able to connect to a network, such as the Internet 30, in order to download or upload information.

The operation of a method for running an auto-run file in the computer 1 as proposed according to the invention will be explained with reference to the flow chart shown in FIG. 2. Commonly, when a new record carrier is inserted into the read/write unit 20 of the drive 2 the drive generates a message “new media inserted” and transmits it to the operating system 3. Thereafter, the operating system 3 sends a request to the drive 2 to read data from a particular location, where file system data, in particular a so-called file system anchor, which is a link to all the file system data, are deemed to be stored. The drive 2 will then return the data from the requested location to the operating system 3 which evaluates these data and sends a further request to the drive 2 to read further file system data indicated by the file system anchor or to read data from a different location, for instance when no file system anchor was available at the first location.

The operating system 3 will also check if an auto-run file is available on the record carrier which will be executed if present. Such an auto-run file may then start running a particular application or performing a particular action as specified in the auto-run file. A user can also start the auto-run file and/or the application manually by means of a particular program such as the Microsoft Explorer after the insertion of the new record carrier. However, when no new record carrier is inserted into the drive 2 or when the record carrier does not contain an auto-run file, this can not be done.

According to the invention a trigger event check unit 23 (also called trigger registration means) is provided in the drive 2 by which the occurrence of a new media inserted trigger event is checked (step S1). Such trigger events can be different events and are used according to the invention to cause the output of a “new media inserted” message (step S2) by the input/output unit 21 of the drive 2 to the operating system 3 (the host). Since such a message is automatically issued by the drive 2 when a new record carrier has in fact physically been inserted into the read/write unit 20, the event check unit 23 does not check such physical insertion as a relevant trigger event, but checks other trigger events as specified in advance. Such trigger events can, for instance, be that a user pushes the button 24, that a predetermined time duration is elapsed or a predetermined point in time has been reached or that a specified type of record carrier or a specified piece of record carrier has been inserted into the read/write unit 20. The drive 2 thus mimics, by issue of the new media inserted message to the operating system 3, the insertion of a new record carrier and thus gets the attention of the operating system 3, although physically a new record carrier has not necessarily been inserted into the drive 2. However, generally when the event is triggered by the insertion of a specified type of record carrier or a specified piece of record carrier, there is a new record carrier inserted into the drive.

The operating system 3 will then (step S3) in response to said new media inserted message issue a read request for reading and returning file system data of said new record carrier in order to know which kind of file system is used on the record carrier. For instance, the operating system 3 will request to read sector 16 which is the file system start address (also called anchor) for an ISO 9660 compliant disc. Further, there might also be different file systems used on the disc having different file system start addresses. In case, the operating system 3 does not get valid or usable file system data in response to the first read requests further read request will be sent to the drive asking the drive to read data from other locations where file system data are typically stored in order to check the presence of valid and usable file system data.

In response to said one or more read requests (S3) the requested file system data will be outputted (step S4) by the drive 2 to the operating system 3. In case no record carrier is present in the read/write unit 20 of the drive 2 such file system data will be taken from the memory 22 of the drive storing file system data for this particular purpose. In another case where a particular type of record carrier or a particular record carrier is present in the read/write unit 20 which triggered the issue of the new media inserted message and which comprises file system data, such file system data might be outputted or, alternatively, file system data stored in the memory 22.

As an example, the drive outputs a piece of data that contains an ISO 9660 file system that, in this example, points to different files, in particular to an auto-run file, to an application and/or an html file, which can also be stored in the memory 22 or, if present, on the record carrier. The operating system 3 will then start reading and running the auto-run file (step S5), which is mimicked by the drive 2 by giving the sectors with the file system data and the auto-run file itself. The auto-run file thereafter (step S6) may have the result that the operating system starts performing certain action, such as e.g. starting certain applications and reading data (e.g. an html file) for that application etc., which are, preferably, also provided to the operating system 3 from the drive 2.

The following example explains the steps of the method in more detail:
1. A new disc is inserted in the drive.
2. The drive issues the “new media inserted” message.
3. The operating system asks the drive for data from e.g. Logical Block Address (LBA) 16.
4. The drive returns data from LBA 16.
5. The operating system evaluates data. Supposing the data is a valid file system anchor. 6. This anchor points to further locations where file system information is located. The operating system will issue further read commands to retrieve all relevant file system information
7. After the drive has read and delivered all the content to the operating system, the operating system knows the entire directory and file structure on the disc.

In the special case where an auto-run file (“autorun.inf”) shall be executed, the following happens:

The operating system will check the files present on the disc. If in the root directory a file with the name “autorun.inf” is found, the operating system will react by reading the data of that file and tries to execute the commands that are listed in that autorun.inf file.

As a particular example of an application, the computer might then contact the web-site of the vendor of the drive or the vendor of the computer. On this web-site information on new products, interesting documents, downloads (e.g. firmware or updates of program that were delivered with the drive) could be available.

In an embodiment a simulated autorun.inf file may be arranged to command the computer to contact a predetermined Internet address to download and install a firmware update in the drive itself. The downloaded firmware may be stored in a flash EEPROM of the drive for example, for subsequent use when commands are sent to the drive. This type of firmware update may be triggered manually, by a command from a user, or automatically by the drive itself.

FIG. 3 shows an embodiment of the drive wherein the drive contains a local processor circuit 30, a firmware memory 32 coupled to the local processor circuit 30, driving circuits 33 controlled by the local processor circuit 30 and hardware and sensors 36 interfaced to local processing circuit 30 via driving circuits 34. Hardware and sensors 36 may include a conventional drive mechanism and drive sensors. Driver circuit 34 may be a conventional driver circuit to drive the drive mechanism and to read data from the sensors.

Local processor circuit 30 has an interface 38 coupled to the PC (not shown) to receive drive commands. In response to such a drive command the local processor circuit 30 retrieves information from the firmware memory 32 that informs the local processor circuit 30 what to do in response to the command. For example, the local processor circuit 30 may start executing instructions from the firmware memory 32, starting from an address that is determined by the drive command. Preferably, the local processor circuit 30 (or some additional error detection circuit (not shown) in the disk drive) is programmed to detect an unexpected error during execution of the instructions (e.g. that the instructions loop for more than a predetermined time, or that an error exception occurs in during execution of an instruction by local processor circuit etc.). In response to detection the local processor circuit 30 sends the “new media inserted” message to the PC and simulates a medium with an autorun file that causes the PC to download new firmware from a predetermined Internet address into the firmware memory of the disk drive.

As an alternative the local processor circuit 30 may be arranged to send such a “new media inserted” message to the PC when it has received a command from the PC for which no information is yet available in the firmware memory. As another alternative the disk drive may contain a timer circuit that triggers the local processor circuit 30 to send such a “new media inserted” message to the PC when a programmed date or time has been reached. In this way periodic firmware updates may be realized. These alternatives may be used singly or in any combination.

In one embodiment the firmware is downloaded into an EEPROM firmware memory 32 of the disk drive. Alternatively the disk drive may be arranged to load its firmware into a volatile firmware memory 32 from a storage device of the PC (e.g. from a hard disk) each time when the disk drive is reset the firmware, or at start up. In this case a small non-volatile firmware memory may be provided that contains sufficient information to enable the local processor circuit 30 to respond to any command after reset by loading the firmware into the volatile memory 32. Alternatively, this response to a command after reset may include generation of a “new media inserted” message to the PC and simulation of an autorun file that causes the PC to load the firmware into the firmware memory 32 from the PC. In this case firmware downloads are stored in the PC.

Further examples are that as an application a certain view on the disc is shown, that a disc is made compliant with a legacy reproduction device and so on. For instance, an application or service could be started to check on a legacy bridge availability in the case of a special Mount Rainier disc that needs to have a bridge file system on the disc to make the disc playable in a legacy video player. Installed as a service or driver, the service can keep track of changes in the special Mount Rainier disc drag & drop user space and when content has changes that are playable on video recorders. When the disc is ejected the service can start a dialog if needed using the method proposed according to the invention.

According to the invention via a specific action, supervised by the drive, the drive mimics the presence of a disc by sending a disc insertion message to the host. After that the drive will give the host (the virtual) file system contents of the virtual disc, which, for instance, contains a link to an auto-run file. This auto-run file tells the host to perform certain actions, such as going to the specified Internet site or executing a file from the virtual disc. Such a drive can be implemented in a computer, but also in a reproduction device such as a disc player.

1. Drive (2) for use in a computer (1) or a reproduction device for accessing a record carrier comprising:
an output means (21) for outputting a new media inserted message indicating that a new record carrier has been inserted in response to a new media inserted trigger event irrespective of the physical insertion of a new record carrier and for outputting file system data in response to a read request,
a trigger registration means (23) for checking the occurrence of said new media inserted trigger event,
an input means (21) for receiving, in response to the output of said new media inserted message, said read request for reading and returning said file system data, and
a carrier access means (20) for reading data from and/or recording data to a record carrier.

2. Drive as claimed in claim 1, wherein said trigger registration means (23) is operative for checking if a particular type of record carrier or a particular record carrier has been inserted into the drive (2).

3. Drive as claimed in claim 2, wherein said carrier access means (20) is operative for reading data from a predetermined location from said record carrier.

4. Drive as claimed in claim 1, wherein said trigger registration means (23) is operative for checking if predetermined time duration has been elapsed or if a predetermined point in time has been reached.

5. Drive as claimed in claim 1, wherein said trigger registration means (23) is operative for checking the occurrence of an eject command.

6. Drive as claimed in claim 1, comprising a local processor circuit arranged to execute a firmware program in response to a drive command, wherein said trigger registration means (23) is operative to respond to detection of an error during execution of the firmware program.

7. Drive as claimed in claim 1, comprising a local processor circuit arranged to execute firmware programs in response to respective drive commands, wherein said trigger registration means (23) is operative to respond to detection of a drive command for which no substantial firmware program is available.

8. Drive as claimed in claim 1, wherein the output means are arranged to simulate a file structure containing an autorun file, the autorun file containing one or more commands for downloading a firmware update for the drive via the Internet.

9. Drive as claimed in claim 8, wherein the drive contains a non-volatile firmware memory, the one or more commands being arranged to cause the update to be loaded into the firmware memory.

10. Drive as claimed in claim 8, wherein the drive contains a volatile firmware memory, and a local processor circuit arranged to load firmware from a memory device in a computer system that contains the drive into the firmware memory, the one or more commands being arranged to load the firmware update into the memory device in the PC.

11. Drive as claimed in claim 1, wherein the drive contains a volatile firmware memory, the output means being arranged to simulate a file structure containing an autorun file, the autorun file containing one or more commands for causing a computer system that contains the drive to download a firmware from a memory device in the system into the firmware memory.

12. Drive as claimed in claim 1, further comprising a user interface (24), in particular a user button, for inputting a trigger command, in particular by pushing said user button, and wherein said trigger registration means (23) is operative for checking the occurrence of said trigger command.

13. Drive as claimed in claim 1, further comprising a memory means (22) for storing said file system data and wherein said output means (21) is operative for outputting said file system data stored in said memory means (22) in response to said read request.

14. Drive as claimed in claim 13, wherein said file system data including a link to a data file, in particular to an auto-run file or an application file, said data file being stored in said memory means (22).

15. Device, in particular computer or reproduction device, having
an operating system (3) for operating the device (1), for running applications and for communicating with a drive (2),
a drive (2) as claimed in claim 1,
wherein said operating system (3) is operative for outputting said read request for reading and returning said file system data to said drive (2) and for evaluating said file system data outputted by said drive (2) in response to said read request.

16. Method of simulating the insertion of a new record carrier into a drive of a computer or a reproduction device comprising the steps of:
checking the occurrence of a new media inserted trigger event,
outputting a new media inserted message indicating that a new record carrier has been inserted in response to said new media inserted trigger event irrespective of the physical insertion of a new record carrier,
receiving, in response to the output of said new media inserted message, a read request for reading and returning file system data, and
outputting said file system data in response to said read request.

17. Computer program comprising program code means for causing a computer to carry out the steps of the method as claimed in claim 16 when said computer program is run on a computer.
